(19) United States
(12) Patent Application Publication
(10) Pub. No.: US 2015/0282253 A1
(43) Pub. Date: Oct. 1, 2015

(54) HEATING DEVICE FOR CONDUCTIVE HEATING OF A SHEET METAL BLANK

(71) Applicant: Benteler Automobiltechnik GmbH, Paderborn (DE)

(72) Inventors: JAN LACKMANN, Paderborn (DE); STEFAN KONRAD, Paderborn (DE); HANS-GERD LAMBERS, Paderborn (DE); ULRICH HUSCHEN, Lichtenau (DE)

(73) Assignee: Benteler Automobiltechnik GmbH, Paderborn (DE)

(21) Appl. No.: 14/671,363

(22) Filed: Mar. 27, 2015

(30) Foreign Application Priority Data
Mar. 28, 2014 (DE) 10 2014 104 398.7

(51) Int. Cl. H05B 3/02; H05B 3/06

(52) U.S. Cl. CPC H05B 3/023; H05B 3/06

(57) ABSTRACT

In a heating device for conductive heating of a sheet metal blank with varying cross sectional surface, the sheet metal blank constitutes a direct component of an electric circuit, wherein an electrically conductive compensation element is provided which is placed onto a surface of the sheet metal blank, wherein a sum of the cross sectional surface of the sheet metal blank and the cross sectional surface of the compensation element results in a current conducting cross sectional surface.

### CROSS-REFERENCES TO RELATED APPLICATIONS

This application claims the priority of German Patent Application, Serial No. 10 2014 104 398.7, filed Mar. 28, 2014, pursuant to 35 U.S.C. 119(a)-(d), the disclosure of which is incorporated herein by reference.

### BACKGROUND OF THE INVENTION

The present invention relates to a heating device for conductive heating of a sheet metal blank.

The following discussion of related art is provided to assist the reader in understanding the advantages of the invention, and is not to be construed as an admission that this related art is prior art to this invention.

It is known in the state of the art to form motor vehicle components from sheet metal blanks, in particular outer motor vehicle parts or also motor vehicle structural parts.

In this regard hot forming and press hardening have become established for producing high strength or even ultra-high-strength components from hardenable steel alloys, especially in the automobile industry.

For performing the hot forming and press hardening at least regions of a sheet metal blank are first heated to austenizing temperature and the sheet metal blank is then formed in this state and hardened by fast cooling in a pressing tool or a downstream cooling device. This process is also known as press hardening.

The heating to above austenizing temperature sometimes involves heating to above 900° C. hence requiring an increased energy input. This means high production costs and also a corresponding burden on the environment due the consumed energy.

In the state of the art conductive heating has become established as heating method in which, due to electric resistance, heat is generated in the blank by means of a current flow conducted through the blank to be heated. Such a method is for example known from DE 102 12 819 B4. For this purpose, electrodes are placed on opposite ends of a sheet metal blank so that the sheet metal blank constitutes a part of an electric circuit. Applying a current thus results in a heat input into the sheet metal blank. In order not to heat certain regions of the sheet metal blank or to heat certain regions only to a small degree in a targeted manner, current conducting solid bodies are placed onto the blank so as to generate a flux leakage of the electric current. In the region of the electrically conducting solid bodies the electric current is partially distributed to the solid bodies and thus does not flow with full current flux density through the sheet metal blank itself but also through the solid bodies.

It would therefore be desirable and advantageous to provide a possibility for heating a sheet metal blank so as to enable an efficient targeted, in particular homogenous, heating of the sheet metal blank by means of conductive heating.

### SUMMARY OF THE INVENTION

According to one aspect of the present invention, a heating device for conductively heating a sheet metal blank with varying cross sectional surface, includes an electrically conductive compensation element placed on the sheet metal plate, the sheet metal plate constituting a direct component of an electric circuit, wherein a sum of a cross sectional surface of the sheet metal blank and a cross sectional surface of the compensation element results in a current conducting cross sectional surface.

The heating device according to the invention for conductive heating of a sheet metal blank having varying cross sectional thickness, wherein the sheet metal blank constitutes a direct component of an electrical circuit, is characterized according to the invention in that an electrically conductive compensation body or compensation element is provided and placed on a surface of the sheet metal blank, wherein the sum of the cross sectional surface of the sheet metal blank and the cross sectional surface of the compensation body results in a current conducting cross sectional surface.

According to the invention a compensation element made of an electrically conductive material is placed at least on a surface, preferably entirely on the surface so that different cross sections of the sheet metal blank can be influenced in a targeted manner through different heating resulting from the different concentration of the current flux density. Within the framework of the invention it is thus possible to heat a sheet metal blank with different wall thicknesses or alternatively to heat sheet metal blanks with constant wall thicknesses but different widths individually partially, preferably homogenously. Hereby the different widths can be influenced by a different absolute width in the respective cross section of the sheet metal blank but also by recesses, openings or passages in the sheet metal blank. When a part of smaller wall thickness and/or smaller width relative to the respective neighboring cross sections is present, a higher current flux density would lead to a stronger heating in the case of a sheet metal blank without compensation element. The compensation element itself provides a compensation of the smaller cross sectional surface of the sheet metal blank by way of a greater cross sectional surface of the compensation element itself, so that by targeted selection of the overall resulting current flow cross sectional surface a targeted adjustment of the heating of the sheet metal blank can be achieved in this region. The respective current flux cross sectional surface results hereby from the sum of the cross sectional surface of the sheet metal blank and the cross sectional surface of the compensation element. This results in an effective or active current conducting cross sectional surface. The compensation element is thus in electrically conductive contact with the sheet metal blank, which is in particular made of a steel material. Within the context of the present invention the term conductive heating means resistive heating in the sheet metal blank due to flow of an electric current.

According to another advantageous feature of the invention the current conducting cross sectional surface is constant so as to result in a homogenous heating over the entire sheet metal blank. Scatter losses or minor deviations due to a greater cross sectional surface of the compensation element relative to a smaller cross sectional surface of the sheet metal blank are negligible within the framework of the invention.

A further significant advantage of the invention is that when the compensation element is contacted with corresponding electrodes, in particular the contact regions or reception regions for the electrodes on the compensation element are configured with a high mass or are relatively thick. This results in a small current flux density in this region, thus resulting in only minor heating on the compensation element. Consequently no separate cooling is required in the region of the connection of the electrodes even in the case of high-load heating with the corresponding compensation element according to the invention.

The heating device according to the invention can in particular be integrated into a production line for producing hot formed and press hardened or heat treated sheet metal components, preferably steel sheet components, wherein heating can be achieved within a very short time, in particular within the production cycle. For this the heating device is preferably fastened on an industrial robot so that the heating device can be used as a manipulator or transport device. In particular a heating device is used for this purpose in order to take up the sheet metal blank from a stack or a conveyor and to transport it to a further processing device, in particular a hot forming press, while simultaneously heating during the transport.

Within the framework of the invention a further positive effect is that the compensation element generally has a greater mass relative to the metal blank, which is also heated. The compensation element then at least partially gives off heat energy contained in it by thermal conduction to the sheet metal plate, which reduces production costs compared to the purely conductive resistance heating. By targeted selection of the cross sectional surface of the hot compensation element, i.e., the compensation element used during the production, it is thus possible to achieve an optimum between heat conduction and conductive heating due to current flow through the sheet metal blank itself.

According to another advantageous feature of the invention the compensation element contacts the surface of the sheet metal blank with its entire surface. In order to improve a full surface contact, the contact surface of the compensation element is in particular configured concave toward the sheet metal blank. It thus has an inward bulge toward the compensation element. The sheet metal blank is thus pulled toward the contact surface.

As an alternative or in addition further a corresponding press force can be exerted via the compensation element, so that a gap between the contact surfaces of the compensation element and the blank is reduced to zero thus resulting in an almost complete contact. Further particularly preferably the compensation element is a part of a pressing tool or a temperature treatment station so that the plate is inserted into the temperature treatment station and then a corresponding pressing force is exerted.

For further enhancing the full surface contact, according to the invention under-pressure channels are provided in the compensation element so that when applying an underpressure on the underpressure channels a suction effect is created for pulling the sheet metal blank to the compensation element.

In addition or as an alternative the compensation element may have mechanical grippers for example in the form of pliers, which engage about the border side of the sheet metal blank.

In order to place or detach the sheet metal blank after the transport and/or heating, preferably push-off elements or pushing tappets are provided which at the placement site push the sheet metal blank against the holding force.

For introducing the electric current it is further preferably provided within the framework of the invention, that the sheet metal blank can be contacted with an electrode at respective opposite ends, wherein either only the sheet metal blank is contacted or as an alternative also the sheet metal blank and the compensation element are each at least partially contacted by the opposing electrodes. By correspondingly selecting especially the percentage distribution it is possible to distribute the current flux density at the introduction points into the sheet metal blank and compensation element in a targeted manner so that a targeted influence of the conductive heating is possible also in the end regions of the sheet metal blank. Preferably the compensation element is provided with electrodes so that the electric current flow is transmitted from the compensation element to the blank.

According to another advantageous feature of the invention the compensation element is made of a scale-resistant steel material or has a scale-resistant coating so that no scaling occurs during the operation of the temperature treatment device. Preferably the contact surface of the temperature treatment device is then in electrically conducting contact with the sheet metal blank. For example the compensation element can also be partially made of carbon or semiconductor materials.

The cross sectional surface of the compensation element can be adjusted by targeted variation of the height or width of the compensation element. Further particularly preferred, two compensation elements are provided so that the top surface or the bottom surface of the sheet metal blank, i.e., the two main surfaces of the sheet metal blank, are contacted by a respective compensation element. In this case the sum of the cross sectional surfaces of the two compensation elements and the cross sectional surface of the sheet metal plate then forms the current flux cross sectional surface, which within the framework of the invention is especially preferably constant in order to achieve a homogenous heating of the sheet metal blank.

According to another advantageous feature of the invention a load distribution plate can be arranged on the side of the compensation element opposite the sheet metal blank, which load distribution plate on one hand stabilizes the compensation element, on the other hand however also influences the forces exerted on the sheet metal blank during the reception, and in particular homogenizes the forces. Also in this case a load distribution plate can again be arranged in a temperature treatment station or in a pressing tool together with the corresponding compensation element and optionally an insulating layer can be arranged there between to establish a uniform contact or compression force and thus an electric conductivity.

According to another advantageous feature of the invention when using two compensation elements the respectively opposing cross sectional surfaces of the two compensation elements can differ from each other. This also enables targeted adjustment the heating to be achieved.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1a and 1b show a blank to be heated in a top view and longitudinal sectional view,

FIGS. 2a and 2b show a compensation element in top view and longitudinal sectional view fitting the plate of FIGS. 1a and 1b,

FIG. 3 the plate of FIG. 1 and the compensation element of FIG. 2 as conductive heating device,

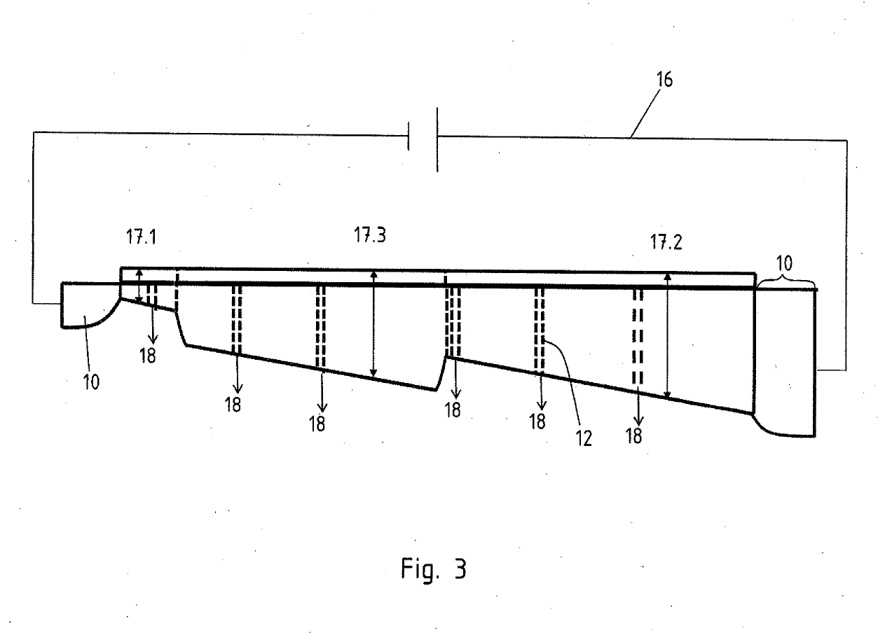

FIGS. 4a to 4c show a compensation element for a B-column in top view, longitudinal sectional view and cross sectional view,

FIGS. 5a and 5b show a B-column heated differently and an associated compensation element,

FIGS. 6a and 6b show a compensation element according to the invention in longitudinal and cross sectional view with mechanical grippers,

FIG. 7 shows two compensation elements arranged on opposing sides,

FIG. 8 shows a compensation element according to the invention with opposing insulation plate,

FIG. 9 shows two compensation elements of different sizes,

FIG. 10 shows a compensation element according to the invention for heating a sheet metal blank having different wall thicknesses; and

FIG. 11 shows a temperature treatment device according to the invention on a robot arm for integration into a hot forming line.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

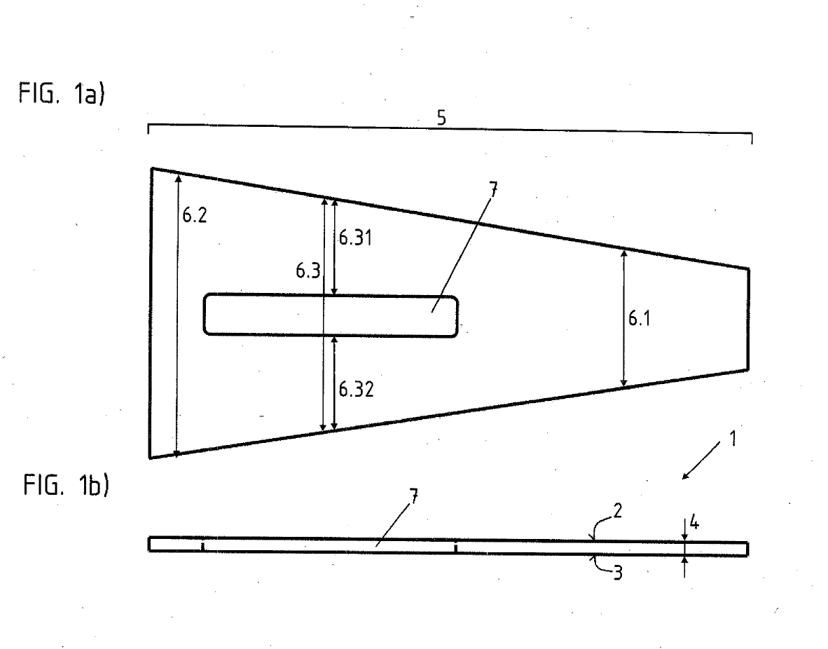

Turning now to the drawing, and in particular to FIG. 1, there is shown a top view and a longitudinal sectional view of a sheet metal blank 1 to be heated. For this purpose the sheet metal blank 1 has two surfaces 2, 3, a top surface 2 on the topside and surface 3 on the bottom side.

The sheet metal blank 1 also has a homogenous wall thickness 4 over its entire length 5. However, the sheet metal blank 1 has a varying width 6 so that the width 6.1 on one side is significantly smaller than the width 6.2 on the opposing side, wherein in the region of a recess 7 a width 6.3 formed by the widths 6.31 and 6.32 results which is different therefrom. The wall thickness 4 multiplied by the respective width 6 then results in a cross sectional surface of the blank on the respective longitudinal section. The cross sectional surface varies in the present case due to the different width 6 and/or the recess 7.

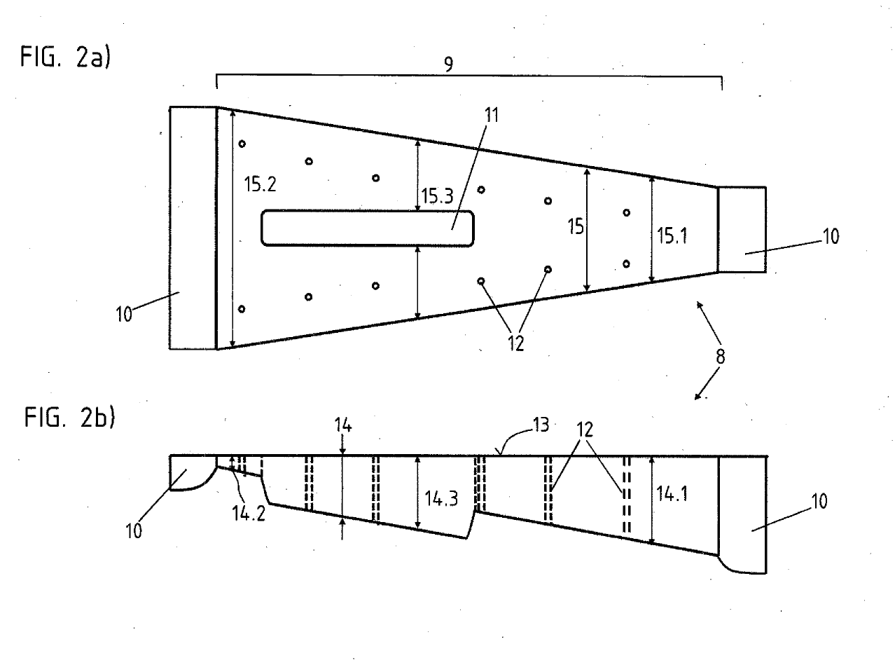

In order to compensate the different cross sectional surfaces of the sheet metal blank 1 resulting from the varying width 6 and the recess 7, a compensation element 8 is provided according to FIGS. 2a and 2b, which according to the top view of FIG. 2a substantially corresponds to the outer dimensions of the sheet metal blank 1. The compensation element also has a length 9, which substantially corresponds to the length 5 of the sheet metal blank 1. In addition current introduction surfaces 10 are provided so that a current for conductive heating can be introduced into the compensation element 8 and in case of electric contact with the sheet metal blank 1 also into the sheet metal blank 1. The compensation element 8 further has a recess 11 corresponding to the recess 7 in the region of the sheet metal blank 1. Further, underpressure channels 12 are arranged in the compensation element 8 in order to suction a sheet metal blank 1 onto the contact surface 13 of the compensation element 8 when an underpressure is applied. A significant part of the invention can be seen in FIG. 2b. Accordingly the wall thickness 4 or the depth 14 of the compensation element 8 is selected at different sites 14.1, 14.2, 14.3 so that the different widths 6 of the blank shown in FIG. 1a are compensated. As a result of the different depths 14 of the compensation element 8 combined with the different widths 15 of the compensation element, shown in FIG. 2a, thus a respective different cross sectional surface of the compensation element 8 results on a longitudinal section. Electrodes 32 can then be connected to the current introduction surface 10 for coupling with a current source.

According to the invention thus a respectively constant current-introduction cross sectional surface 17 (indicated by arrows) results in the case of an electric circuit 16 closed by the compensation element 8, which is composed of the respective cross sectional surface of the sheet metal blank 1 and the cross sectional surface of the compensation element 8, which in turn results from the width and wall thickness or depth. Further shown is an underpressure 18 applied to the underpressure channels 12 for suctioning the sheet metal blank 1 to the compensation element 8 in order to realize an electric, in particular full surface, contact.

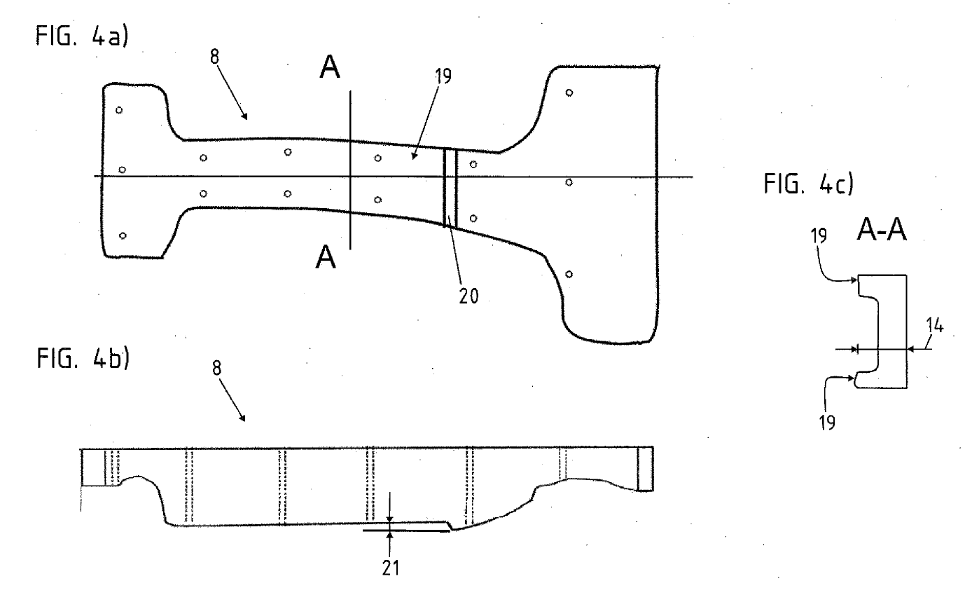

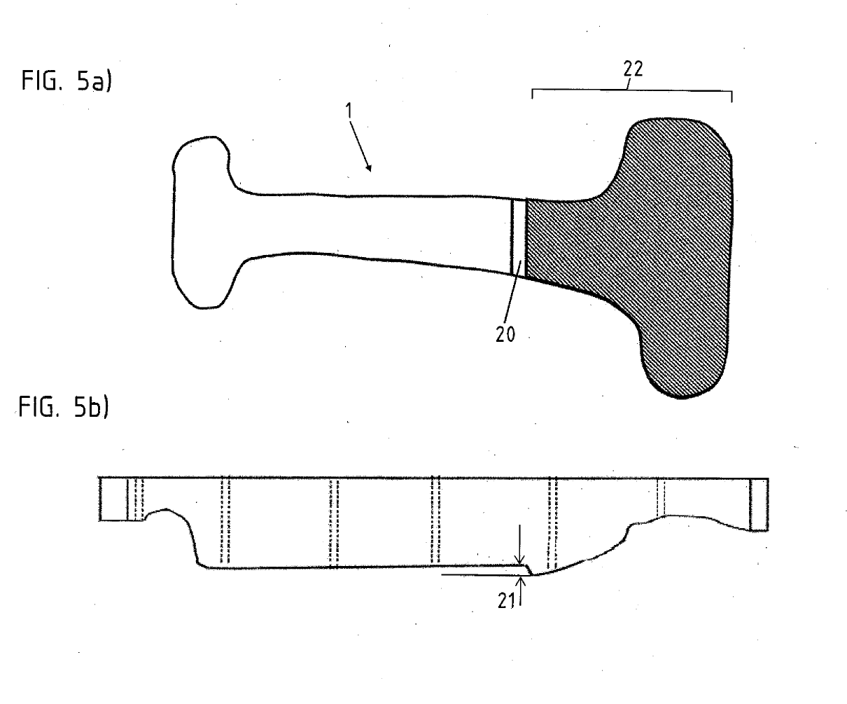

FIGS. 4a and c show a compensation element 8 having an increased depth 14 in border regions 19 according to the cross sectional view A-A in FIG. 4c in order to achieve a softer region owing to a smaller current flow in the blank and thus less heating especially in the border region 19 of the blank to be heated, for example a shown B-column. Further shown is a border 20 at which a targeted Delta 21 is established in the cross sectional surface of the compensation element 8 in order according to FIG. 5a to establish regions of different strengths at a border 20 on a shown sheet metal blank 1 for producing a B-column. In the region of the Delta 21 a greater cross sectional surface of the compensation element 8 is thus present so that in a lower region 22 of the sheet metal blank 1 a smaller heating occurs due to the larger cross sectional surface of the compensation element 8, and associated therewith a smaller current flux density in the sheet metal blank 1 in this region. Not further shown are the increased border regions 19 according to FIG. 4c, which would also establish different strengths in the sheet metal blank 1 according to FIG. 5a.

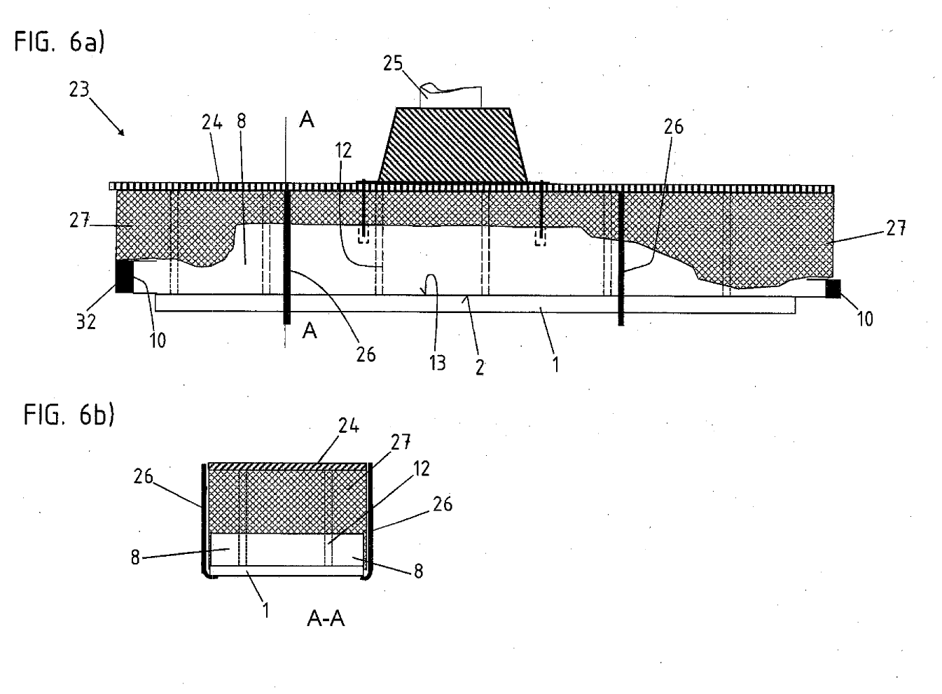

Further shown in FIGS. 6a and b is an embodiment of the heating device 23 according to the invention, having the compensation element 8 and a load distribution plate 24 situated behind the compensation element 8 and an integrated insulation plate 27, wherein the compensation element 8 is arranged on a gripping arm 25 of a not further shown industrial robot via the load distribution plate 24. Thus again in association with the underpressure channels 12, the blank is suctioned and further fixed in position via outside arranged pliers 26 so that a contact between the surface 2 and the sheet metal blank 1 and a contact surface 13 of the compensation elements 8 is formed. In addition an insulating plate 27 is arranged between the load distribution plate 24 and the compensation element 8, which prevents heat dissipation from the compensation element 8 to the load distribution plate 24. Further shown on the ends of the compensation element 8 is a current introduction surface 10, which is coupled with electrodes 32 for applying a current.

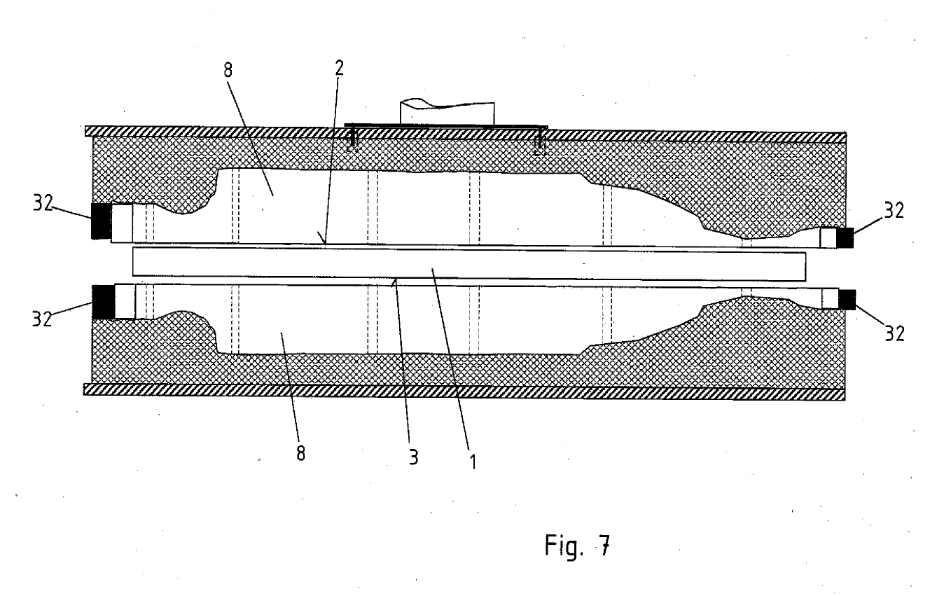

Further shown in FIG. 7 is an embodiment with two compensation elements 8, which are configured mirror symmetric and contact the sheet metal blank 1 from both surfaces 2, 3. The cross sectional surface of the sheet metal blank 1 to be compensated by the compensation element 8 is thus compensated on the image plane on top and bottom by a respectively arranged compensation element 8. In this embodiment a current can then be applied to the respective compensation elements 8, alternatively however a current may also be applied to only one of the compensation elements.

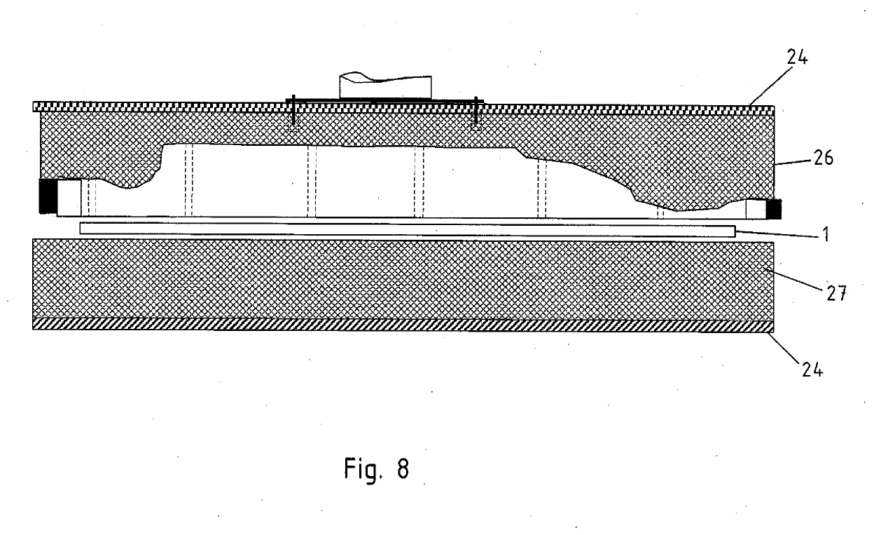

FIG. 8 shows an alternative embodiment with a bottom insulation plate 27. Hereby the compensation element 8 can press the sheet metal blank 1 in the direction of the insulation plate 27 which again improves contact. Also in this case a load distribution plate 24 is arranged behind the compensation element 8 but also behind the insulation plate 27.

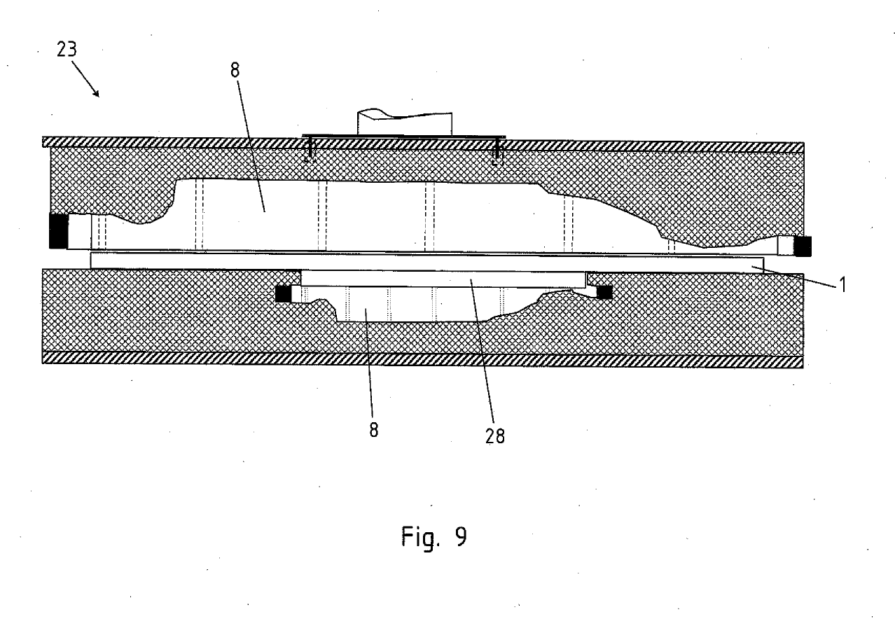

FIG. 9 shows a further embodiment of a heating device 23 according to the invention, wherein the compensation elements 8 have different cross sectional surfaces. This can for example be used for temperature treatment of a sheet metal blank 1 with a patch 28 or for a not further shown sheet metal blank 1 with different wall thicknesses 4. In particular a corresponding patch 28 is fixed on the sheet metal blank 1 for example by gluing or a welding process or a gluing or corresponding enamel.

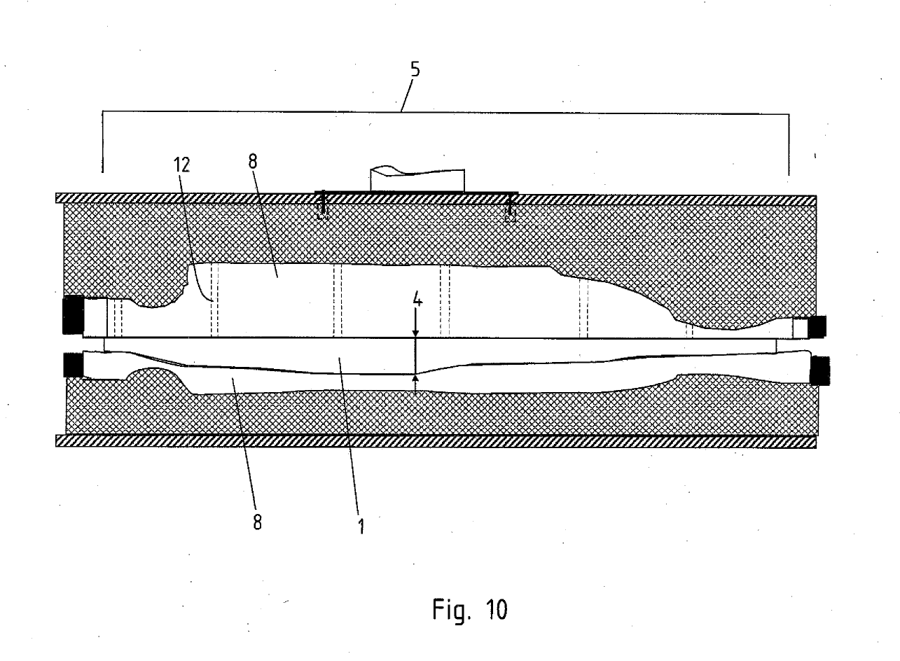

This is shown in more detail in FIG. 10. Shown is a sheet metal blank 1 with wall thicknesses 4 that differ in longitudinal direction, which in this embodiment are enclosed by a top compensation a element 8 and a bottom compensation element 8. The top compensation element 8 has underpressure channels 12 so that the sheet metal blank 1 can for example be taken up with the top compensation element 8, and then placed into the bottom compensation element, wherein the temperature treatment is then applied. Along its length 5 the sheet metal blank 1 itself has wall thicknesses 4 that differ from each other. All previously mentioned embodiments, and in particular the embodiment shown in FIG. 10, can thus also be integrated in a temperature treatment station, a pressing tool or a fixing tool. For this the half which is situated on top in the image plane, and here in particular the upper compensation element 8, is lifted for inserting a blank and subsequently lowered in order to be placed onto the blank with in particular homogenously distributed compression pressure. The load distribution plate 24 can be part of a top tool and/or bottom tool of the temperature treatment station or the pressing tool or the fixing tool, wherein a gripper arm 25 according to FIGS. 6 to 10 is not required in these cases.

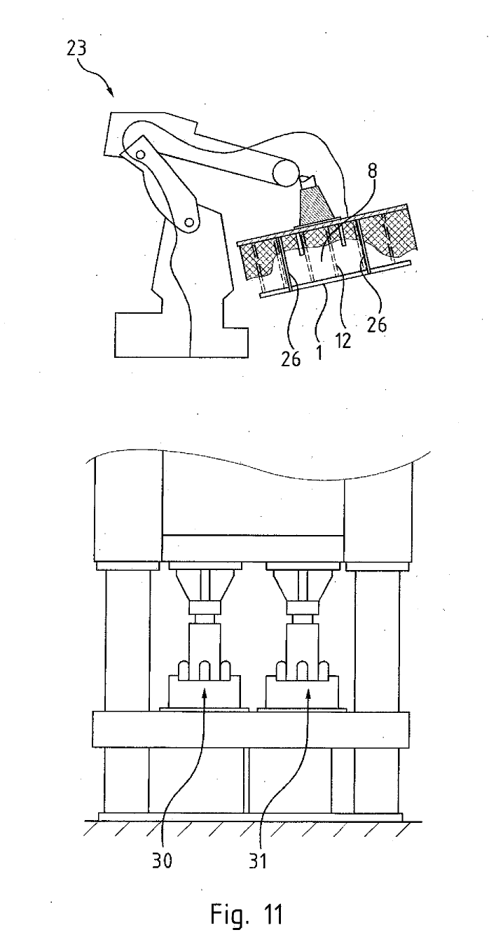

A possible field of application of a heating device 23 according to the invention is shown in FIG. 11. Hereby an industrial robot 29 is shown which has taken up a sheet metal blank 1 by means of the compensation element 8 according to the invention, wherein also corresponding pliers 26 are shown which fix the sheet metal blank 1 in the taken up state in addition to the underpressure channels 12. The underpressure channels 12 or pliers 26 can however also be used individually by themselves. The thus heated sheet metal blank 1 is then transferred into a hot forming device 30 in which it can be hot formed and optionally also press hardened or alternatively transferred into a downstream press hardening device 31 or combined cutting device.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A heating device for conductively heating a sheet metal blank with varying cross sectional surface, comprising:
an electrically conductive compensation element placed on the sheet metal plate, said sheet metal plate constituting a direct component of an electric circuit, wherein a sum of a cross sectional surface of the sheet metal blank and a cross sectional surface of the compensation element results in a current conducting cross sectional surface.

2. The heating device of claim 1, constructed for heating a sheet metal blank having a homogenous wall thickness or variable wall thicknesses.

3. The heating device of claim 1, wherein the sheet metal blank has recesses and/or holes.

4. The heating device of claim 1, constructed for homogeneous heating of the sheet metal blank, wherein the sum of the cross sectional surface of the sheet metal blank and the cross sectional surface of the compensation element results in a constant current conducing cross sectional surface.

5. The heating device of claim 1, comprising two said compensation elements placed on respective surfaces of the sheet metal blank.

6. The heating device of claim 1, wherein the compensation element is formed concave on a contact surface facing the sheet metal blank.

7. The heating device of claim 1, wherein underpressure channels are provided in the compensation element so that the sheet metal blank is pulled to the compensation element as a result of underpressure applied to the underpressure channels.

8. The heating device of claim 1, wherein the heating device is constructed so that the sheet metal blank is contactable at respectively opposing ends with a current introduction surface or so that the sheet metal blank and the compensation element can be contactable simultaneously with a current introduction surface or so that respective opposing ends of the compensation element are contacted with current introduction surfaces or so that one end is contacted with the sheet metal blank and the opposing end is contacted with the compensation element.

9. The heating device of claim 1, wherein the compensation element is made of a scale-resistant material or wherein the contact surface of the compensation element is coated with a scale-resistant coating.

10. The heating device of claim 1, wherein compensation element is fastened on an industrial robot and is usable as a manipulator of the sheet metal blank.

11. The heating device of claim 1, wherein a sum of the cross sectional surface of the sheet metal blank and the cross sectional surface of the compensation element results in a current conducting cross sectional surface which varies over the length of the sheet metal blank thereby enabling heating regions of the sheet metal blank to different temperatures.

12. The heating device of claim 1, wherein the heating device is configured as a pressing tool or fixing tool or temperature treatment station, wherein the sheet metal blank is insertable into the heating device and the compensation element is pressable onto the sheet metal blank.
